(19) United States
(12) Patent Application Publication
(10) Pub. No.: US 2008/0259290 A1
(43) Pub. Date: Oct. 23, 2008

(54) PROJECTION APPARATUS

(75) Inventors: Sze-Ke Wang, Hsinchu (TW); Chin-Ku Liu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/946,059

(22) Filed: Nov. 28, 2007

(30) Foreign Application Priority Data
Apr. 23, 2007 (TW) 96114214

(51) Int. Cl. G03B 21/28

(52) U.S. Cl. 353/81; 353/98

(57) ABSTRACT

A projection apparatus including an illumination system, a reflective light valve, at least one field lens and, an imaging system is provided. The illumination system is for providing an illumination beam and the reflective light valve is on a transmission path of the illumination beam to convert the illumination beam into an image beam. The field lens is disposed to face a reflective surface of the reflective light valve and on transmission paths of the illumination beam and the image beam. The imaging system includes a projection lens and a first reflective element, in which the first reflective element is on a transmission path of the image beam, and outside the transmission path of the illumination beam, so as to reflect the image beam to the projection lens. An optic axis of the projection lens is perpendicular to a normal vector of the reflective surface of the reflective light valve.

### CROSS-REFERENCE TO RELATED APPLICATION

This application claims the priority benefit of Taiwan application serial no. 96114214, filed on Apr. 23, 2007. The entirety of the above-mentioned patent application is hereby incorporated by reference herein and made a part of this specification.

### BACKGROUND OF THE INVENTION

1. Field of the Invention

The present invention relates to a display apparatus. More particularly, the present invention relates to a projection apparatus.

2. Description of Related Art

FIGS. 1A and 1B show schematic structural views of two conventional projection apparatuses. Referring to FIG. 1A, the conventional projection apparatus 100a includes an illumination system 110a, a digital micro-mirror device (DMD) 120, and an imaging system 130. The digital micro-mirror device 120 is disposed between the illumination system 110a and the imaging system 130. The illumination system 110a includes a light source 112, a light integration rod 113, a plurality of lenses 114, and two reflective mirrors 116a, 116b. The light source 112 is suitable to provide an illumination beam 112a. After passing through the light integration rod 113 and the lens 114, the illumination beam 112a is reflected by the reflective mirror 116a to the reflective mirror 116b, and is then reflected by the reflective mirror 116b to the lens 114 most close to the digital micro-mirror device 120. Afterwards, the illumination beam 112a is incident on the digital micro-mirror device 120, and the digital micro-mirror device 120 converts the illumination beam 112a into an image beam 112a′, and makes the image beam 112a′ to be incident on the imaging system 130. Next, the imaging system 130 projects the image beam 112a′ onto a screen (not shown) to form an image on the screen.

FIG. 1B is similar to FIG. 1A, except that the illumination system 110b of the projection apparatus 100b includes a light source 112, a light integration rod 113, a plurality of lens 114, and a reflective mirror 116a. After passing through the light integration rod 113 and the lens 114, an illumination beam 112a provided by the light source 112 is reflected by the reflective mirror 116a to the digital micro-mirror device 120 which converts the illumination beam 112a into an image beam 112a′, and makes the image beam 112a′ to be incident on the imaging system 130. Next, the imaging system 130 projects the image beam 112a′ onto a screen (not shown) to form an image on the screen.

The structures of the two projection apparatuses 100a, 100b are designed to have an optic axis of the imaging system 130 being substantially parallel to the normal vector of a reflective surface 122 of the digital micro-mirror device 120, thereby the projection apparatuses 100a, 100b have a larger width (i.e. a total length of the projection apparatus 100a, 100b along X axis is larger). Additionally, in the projection apparatus 100a, as the imaging system 130 is disposed above the lens 114 most close to the digital micro-mirror device 120, the projection apparatus 100a has a larger thickness (i.e. the total length of the projection apparatus 100b along Z axis is larger). Furthermore, in the projection apparatus 100b, as the imaging system 130 is disposed above the reflective mirror 116a, the projection apparatus 100b has a larger thickness (i.e. the total length of the projection apparatus 100b along Z axis is larger).

Based on the above, in the trend of pursuing thin electronic products, the architecture of the conventional projection apparatus 100a, 100b may not satisfy the requirements.

### SUMMARY OF THE INVENTION

Accordingly, the present invention is directed to providing a projection apparatus having a smaller thickness than that of the conventional projection apparatus.

In one embodiment of the present invention, a projection apparatus including an illumination system, a reflective light valve, at least one field lens, and an imaging system is provided. The illumination system is suitable for providing an illumination beam, the reflective light valve is disposed on a transmission path of the illumination beam to convert the illumination beam into an image beam. The field lens is disposed to face a reflective surface of a reflective light valve, and located on transmission paths of the illumination beam and the image beam. The imaging system includes a projection lens and a first reflective element, and the first reflective element is disposed on the transmission path of the image beam and located outside the transmission path of the illumination beam, so as to reflect the image beam to the projection lens. Additionally, an optic axis of the projection lens is substantially perpendicular to a normal vector of a reflective surface of the reflective light valve.

In another embodiment of the present invention, a projection apparatus including an illumination system, a reflective light valve, at least one field lens, and an imaging system is provided. The illumination system is suitable for providing an illumination beam, the reflective light valve is disposed on the transmission path of the illumination beam to convert the illumination beam into an image beam. The field lens is disposed to face a reflective surface of the reflective light valve, and located on transmission paths of the illumination beam and the image beam. The imaging system includes a projection lens and a first reflective element, and the first reflective element is disposed on the transmission path of the image beam to convert the image beam to the projection lens. Additionally, the projection lens and the illumination system are located at two opposite sides of the first reflective element.

In the projection apparatus of the present invention, since the illumination system and the imaging system share one field lens, the thickness of the projection apparatus may be reduced effectively. Additionally, in the present invention, the projection lens and the illumination system are disposed at two opposite sides of the first reflective element, so as to make the optic axis of the projection lens substantially unparallel to or perpendicular to the normal vector of a reflective surface of the reflective light valve, thereby the width of the projection apparatus may be reduced.

In order to the make aforementioned and other objects, features and advantages of the present invention comprehensible, preferred embodiments accompanied with figures are described in detail below.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are schematic structural views of two conventional projection apparatuses.

FIG. 2 is a schematic view of a projection apparatus according to an embodiment of the present invention.

FIGS. 3A to 3B are schematic views of projection apparatuses according to another two embodiments of the present invention.

FIG. 4 is a top view of a projection apparatus according to another embodiment of the present invention.

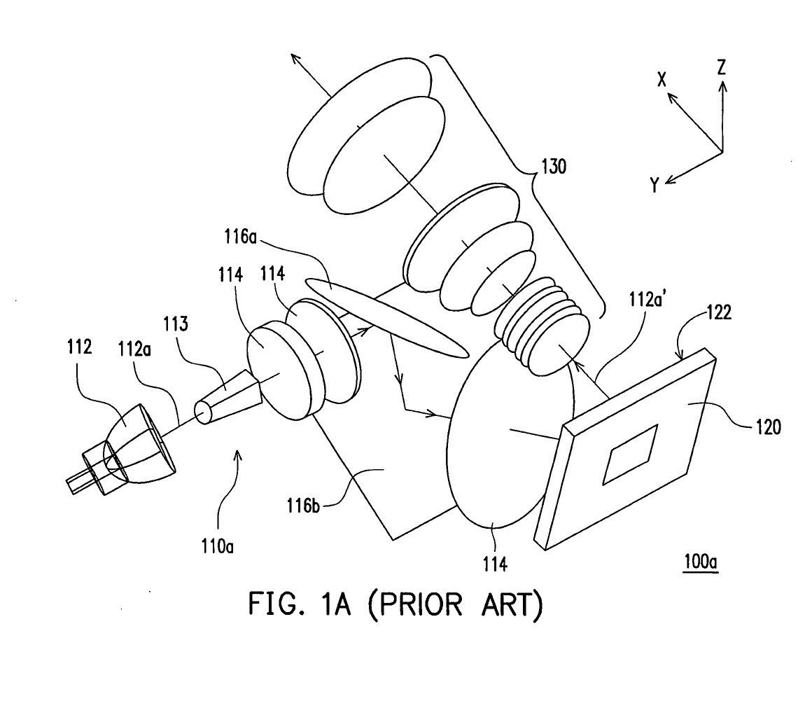

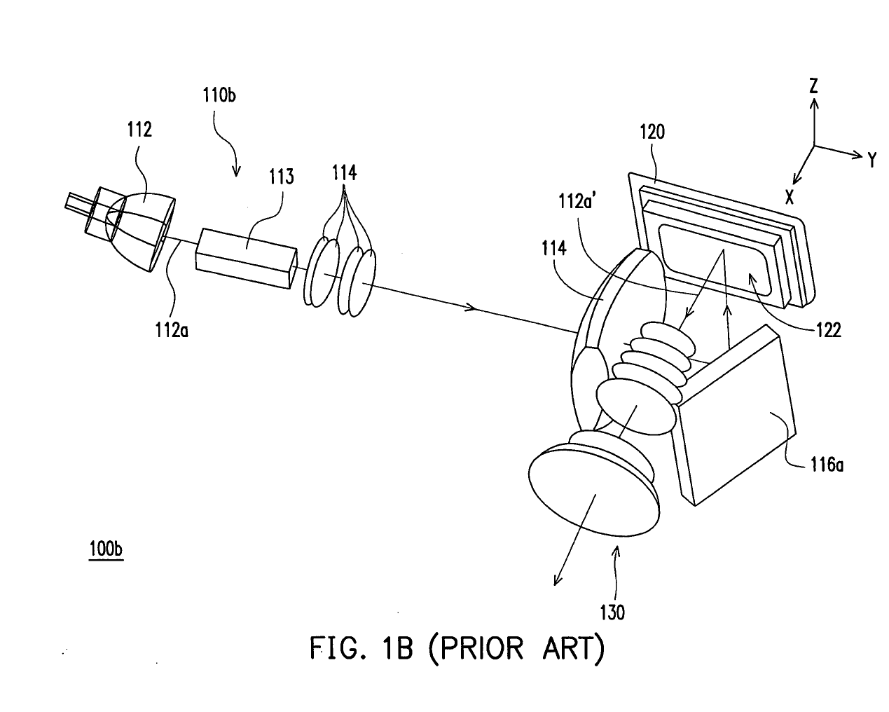

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

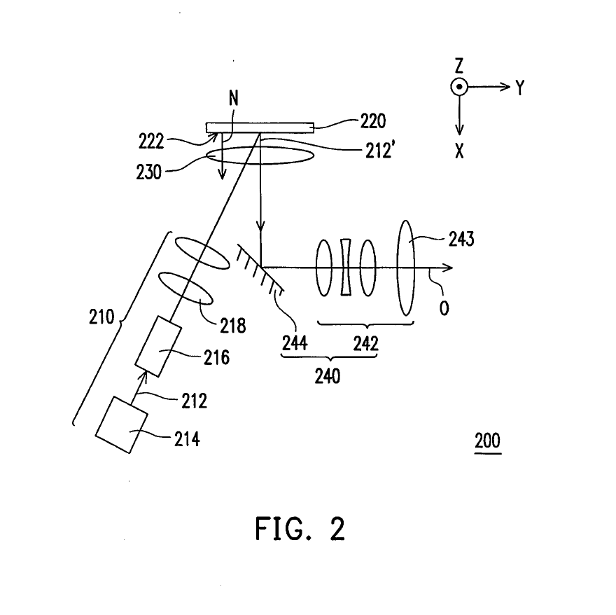

FIG. 2 is a schematic view of a projection apparatus according to an embodiment of the present invention. Referring to FIG. 2, a projection apparatus 200 of this embodiment includes an illumination system 210, a reflective light valve 220, a field lens 230, and an imaging system 240. The illumination system 210 is suitable for providing an illumination beam 212, and the reflective light valve 220 is disposed on the transmission path of the illumination beam 212 to convert the illumination beam 212 to an image beam 212′. The field lens 230 is disposed to face the reflective surface 222 of the reflective light valve 220, and located on the transmission paths of the illumination beam 212 and the image beam 212′. The imaging system 240 includes a projection lens 242 and a first reflective element 244, and the first reflective element 244 is disposed on the transmission path of the image beam 212′ to reflect the image beam 212′ to the projection lens 242. The projection lens 242 projects the image beam 212′ on a screen (not shown) to form an image on the screen. Additionally, in an embodiment of the present invention, the projection lens 242 and the illumination system 210 are located at two opposite sides of the first reflective element 244. The first reflective element 244 is, for example, outside the transmission path of the illumination beam 212.

In an embodiment of the projection apparatus 200, the illumination system 210 may include, for example, a light source 214, a light integration rod 216, and at least one lens 218. The integration rod 216 is disposed between the light source 214 and the lens 218. The light source 214 is used to provide an illumination beam 212, and the light integration rod 216 is used to uniform the illumination beam 212. The lens 218 and the field lens 230 are used to focus the illumination beam 212 on the reflective light valve 220. Moreover, the illumination system 210 may further include a color wheel (not shown), which is disposed on the transmission path of the illumination beam 212, so as to separate the illumination beam 212 into various color lights, such as red, blue, and green lights sequentially.

As described above, the reflective light valve 220 may be a digital micro-mirror device (DMD) or liquid crystal on silicon panel (LCOS panel). Additionally, the projection lens 242 includes a plurality of lenses 243, and an optic axis O of the projection lens 242 is not parallel to a normal vector N of the reflective surface 222 of the reflective light valve 220. In this embodiment, the optic axis O of the projection lens 242 is substantially perpendicular to the normal vector N of the reflective surface 222 of the reflective light valve 220. Furthermore, the first reflective element 244 may be a reflective mirror, and the reflective mirror is, for example, a plane reflective mirror.

In this embodiment, as the illumination system 210 and the imaging system 240 share one field lens 230, the thickness of the projection apparatus 200 may be reduced effectively. Additionally, of this embodiment, the design of reflecting the image beam 212′ to the projection lens 242 by the use of the first reflective element 244 may make the optic axis O of the projection lens 242 to be substantially perpendicular to the normal vector N of the reflective surface 222 of the reflective light valve 220. Therefore, the width of the projection apparatus 200 may be reduced (i.e. the total length of the projection apparatus 200 along X axis is reduced).

In this embodiment, the number of the field lens 230 is not limited. In consideration of image quality, in the projection apparatus 200 of this embodiment, the number of the field lens 230 may be one or more.

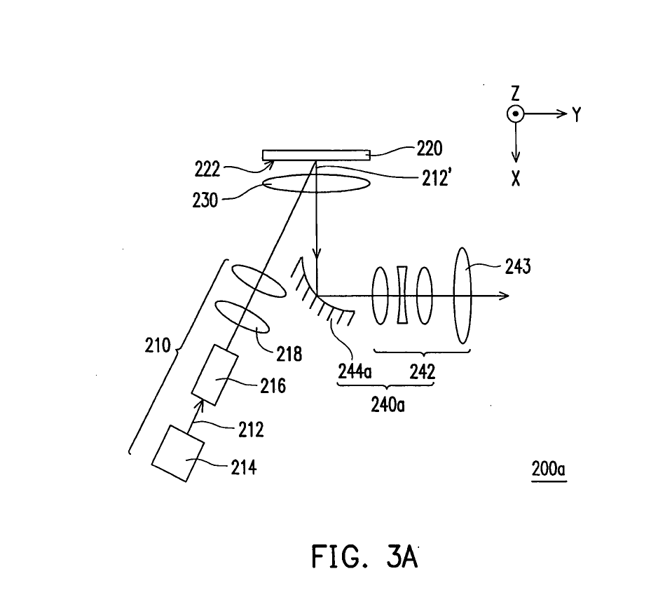

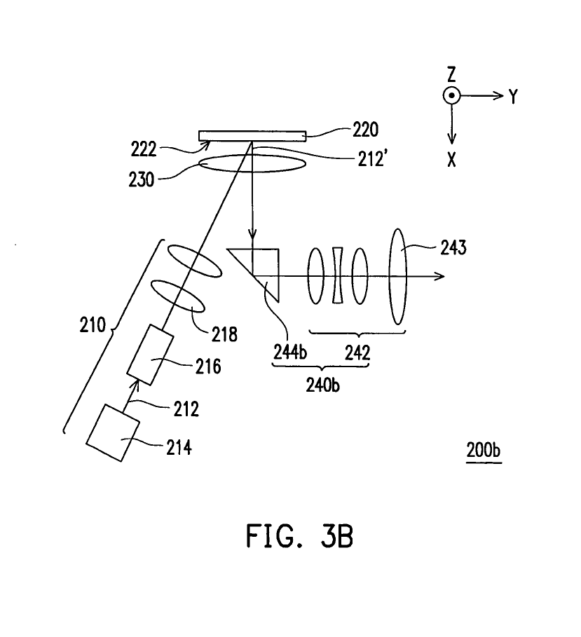

FIGS. 3A to 3B are schematic views of projection apparatuses according to another two embodiments of the present invention. The projection apparatuses according to the two embodiments have similar architectures and advantages of the projection apparatus 200 in FIG. 2, and only the differences therebetween are illustrated hereinafter. Firstly, referring to FIG. 3A, in an imaging system 240a of a projection apparatus 200a, the first reflective element 244a is a curved reflective mirror, but in an imaging system 240b of a projection apparatus 200b in FIG. 3B, a first reflective element 244b is a prism. In other words, in the present invention, the first reflective element may be a reflective mirror or a prism, and the reflective mirror may be a plane reflective mirror or a curved reflective mirror.

In order to further reduce the width of the projection apparatus, in the present invention, at least one second reflective element may be additionally disposed between the illumination system and the reflective light valve, which will be illustrated in the following embodiments accompanied with drawings.

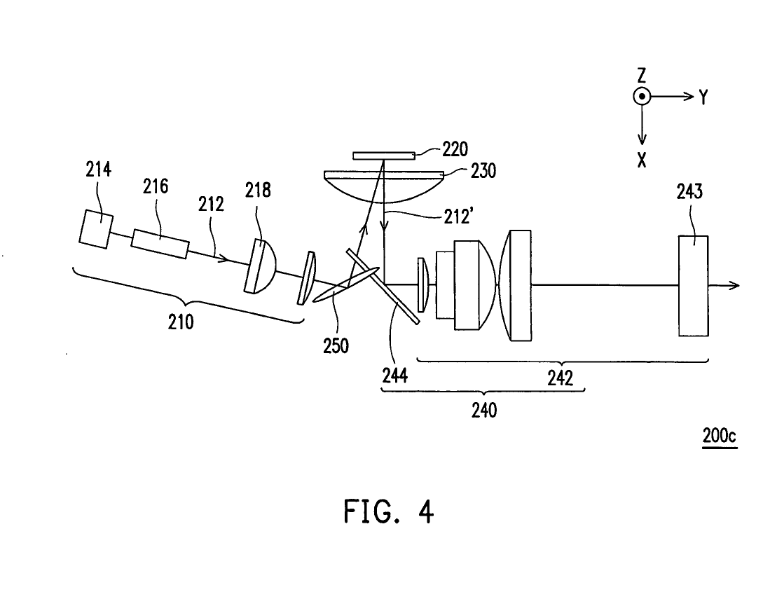

FIG. 4 is a top view of a projection apparatus according to another embodiment of the present invention. Referring to FIG. 4, compared with the projection apparatus 200 in FIG. 2, the projection apparatus 200c of this embodiment further includes a second reflective element 250. The second reflective element 250 is disposed on the transmission path of the illumination beam 212, so as to reflect the illumination beam 212 to the reflective light valve 220. In this embodiment, the second reflective element 250 is, for example, disposed on the first reflective element 244.

In FIG. 4, the second reflective element 250 is a plane reflective mirror, but it may also be another reflective mirror (such as curved reflective mirror) or a prism.

As the projection apparatus 200c has the second reflective element 250 for reflecting the illumination beam 212 to the reflective light valve 220, the elements in the illumination system 210 may be substantially disposed along Y axis. In this way, the width (i.e. the total length along X axis) of the projection apparatus 200c may be further reduced.

It should be noted that the first reflective element 244 in FIG. 4 is a plane reflective mirror, but it may also be another reflective mirror (such as curved reflective mirror) or a prism. Additionally, the number of the second reflective element 250 is not limited in this embodiment. That is to say, the manufacturer may dispose a plurality of second reflective elements 250 in the projection apparatus according to different requirements.

In view of above, the projection apparatus according to the embodiments of the present invention has at least one or a part of or all of the following advantages.

1. The illumination system and the imaging system share one field lens according to the present invention, so the thickness of the projection apparatus may be effectively reduced.

2. The projection lens and the illumination system are disposed at two opposite sides of first reflective element, and the optic axis of the projection lens is unparallel to or perpendicular to the normal vector of the reflective surface of the reflective light valve, so the width of the projection apparatus may be reduced.

3. As the second reflective elements are additionally disposed in the illumination system to reflect the illumination beam to the reflective light valve, the extending direction of the illumination system may be substantially the same as that of the imaging system, so that the width of the projection apparatus may be effectively reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
an illumination system, for providing an illumination beam;
a reflective light valve, disposed on a transmission path of the illumination beam to convert the illumination beam into an image beam;
at least one field lens, disposed to face a reflective surface of the reflective light valve, and located on transmission paths of the illumination beam and the image beam; and
an imaging system, comprising:
a projection lens; and
a first reflective element, disposed on a transmission path of the image beam, and located outside the transmission path of the illumination beam, so as to reflect the image beam to the projection lens, wherein an optic axis of the projection lens is substantially perpendicular to a normal vector of the reflective surface of the reflective light valve.

2. The projection apparatus as claimed in claim 1, wherein the first reflective element is a reflective mirror.

3. The projection apparatus as claimed in claim 2, wherein the reflective mirror is a plane reflective mirror or a curved reflective mirror.

4. The projection apparatus as claimed in claim 1, wherein the first reflective element is a prism.

5. The projection apparatus as claimed in claim 1, further comprising at least one second reflective element disposed on the transmission path of the illumination beam, so as to reflect the illumination beam to the reflective light valve.

6. The projection apparatus as claimed in claim 5, wherein the second reflective element is a reflective mirror.

7. The projection apparatus as claimed in claim 6, wherein the reflective mirror is a plane reflective mirror or a curved reflective mirror.

8. The projection apparatus as claimed in claim 5, wherein the second reflective element is a prism.

9. A projection apparatus, comprising:
an illumination system, for providing an illumination beam;
a reflective light valve, disposed on a transmission path of the illumination beam to convert the illumination beam into an image beam;
at least one field lens, disposed to face a reflective surface of the reflective light valve, and located on transmission paths of the illumination beam and the image beam; and
an imaging system, comprising:
a projection lens; and
a first reflective element, disposed on a transmission path of the image beam, so as to reflect the image beam to the projection lens, wherein the projection lens and the illumination system are located at two opposite sides of the first reflective element.

10. The projection apparatus as claimed in claim 9, wherein the first reflective element is located outside the transmission path of the illumination beam.

11. The projection apparatus as claimed in claim 9, further comprising at least one second reflective element disposed on the transmission path of the illumination beam, so as to reflect the illumination beam to the reflective light valve.

12. The projection apparatus as claimed in claim 9, wherein an optic axis of the projection lens is substantially perpendicular to a normal vector of the reflective surface of the reflective light valve.
